(19) United States
(12) Patent Application Publication
(10) Pub. No.: US 2015/0161618 A1
(43) Pub. Date: Jun. 11, 2015

(54) Aircraft Configuration and Software Part Management Using a Configuration Software Part

(71) Applicant: The Boeing Company, Chicago, IL (US)

(72) Inventors: Ian Gareth Angus, Mercer Island, WA (US); Olga C. Walker, Mercer Island, WA (US)

(73) Assignee: The Boeing Company, Chicago, IL (US)

(21) Appl. No.: 14/097,982

(22) Filed: Dec. 5, 2013

(51) Int. Cl. G06Q 30/00

(52) U.S. Cl. CPC G06Q 30/018

(57) ABSTRACT

A system and method of using a configuration software part for an aircraft. A processor unit on the aircraft identifies software parts for the aircraft from a list of approved software parts for an approved software configuration for the aircraft in the configuration software part. The approved software configuration for the aircraft is identified in the configuration software part and the configuration software part is stored on the aircraft. The processor unit on the aircraft determines whether the software parts identified in the configuration software part are on the aircraft.

### BACKGROUND INFORMATION

1. Field

The present disclosure relates generally to aircraft and, in particular, to software aircraft parts and the configuration of software on an aircraft. Still more particularly, the present disclosure relates to a method and apparatus for managing software aircraft parts and the software configuration of an aircraft using a software part for the aircraft that defines an approved software configuration for the aircraft.

2. Background

Modern aircraft are extremely complex. For example, an aircraft may have many types of electronic systems on board. An electronic system on an aircraft may be a line-replaceable unit (LRU). A line-replaceable unit is designed to be easily replaceable. A line-replaceable unit may be replaced when the aircraft is in flight or while the aircraft is on the ground.

An electronic system may take on various forms. An electronic system on an aircraft may be, for example, without limitation, a flight management system, an autopilot, an in-flight entertainment system, a communications system, a navigation system, a flight controller, a flight recorder, and a collision avoidance system. The various electronic systems on an aircraft may communicate with each other via digital airplane networks.

Electronic systems may use software or programming to provide the logic or control for various operations and functions. The software used in these electronic systems is commonly treated as parts in the airline industry. In particular, a software application for use in a line-replaceable unit on an aircraft may be tracked separately from the line-replaceable unit itself. Aircraft software that is treated as an aircraft part may be referred to as a loadable software aircraft part, an aircraft software part, or simply as a software part. A software part may be considered part of the configuration of an aircraft, rather than part of the hardware which operates the software.

Aircraft operators are entities that operate aircraft. Examples of aircraft operators include airlines and military units. Aircraft operators may be responsible for the maintenance and repair of aircraft. Maintenance and repair of an aircraft may include loading software parts on the aircraft.

Software parts are typically already installed in the electronic systems on an aircraft when an aircraft operator receives an aircraft. For example, software parts for the electronic systems may be provided by the aircraft manufacturer and installed on the aircraft by the aircraft manufacturer before the aircraft is delivered to the operator. The aircraft operator may also receive copies of these loaded software parts in case the parts need to be reinstalled or reloaded into the electronic systems on the aircraft. Reloading of software parts may be required, for example, if a line-replaceable unit in which the software is used is replaced or repaired.

An aircraft operator also may receive updates to the software parts from the aircraft manufacturer from time to time. These updates may include additional features not present in the currently-installed software parts and may be considered upgrades to one or more electronic systems. These updates also may be loaded on the aircraft by the aircraft operator.

An aircraft operator also may provide software parts for an aircraft. Operator provided software parts may be loaded on the aircraft by the aircraft manufacturer before the aircraft is delivered to the operator. Operator provided software parts also may be loaded on the aircraft by the operator after delivery. For example, operator software parts that were installed on the aircraft by the manufacturer may need to be reloaded on the aircraft in some cases. Updates to the operator software parts also may be loaded on the aircraft by the operator from time to time.

Specified procedures may be followed by the operator of an aircraft during loading of manufacturer and operator provided software parts on an aircraft so that the current configuration of the aircraft is known. The software configuration of an aircraft includes all of the software parts loaded on the aircraft.

It may be desirable both to know the current software configuration of an aircraft and to know that the current software configuration of the aircraft has been approved by the aircraft manufacturer, the aircraft operator, or both. For example, regulatory agencies may require an aircraft operator to ensure that the configuration of an aircraft is known and meets approval. However, current systems and methods may not provide for the effective and efficient management of the software configuration of a modern aircraft.

Effective and efficient software part management is also desirable. Software part management for a modern aircraft may include managing a large number of manufacturer and operator provided software parts both in preparation for loading the software parts on an aircraft and after the software parts have been loaded on the aircraft. For example, modern aircraft have the capability to store software parts on the aircraft before the software parts are installed on various aircraft systems. Storing various software parts on the aircraft facilitates accessibility to the software parts when installation of the software parts on the aircraft systems is required. Effective management of the storage of software parts on the aircraft is desirable for efficient maintenance of the aircraft. Current systems and methods do not provide for the effective and efficient management of software parts for modern aircraft when the aircraft software parts are stored on the ground, before being loaded on an aircraft, or when the software parts are stored on the aircraft.

Accordingly, it would be beneficial to have a method and apparatus that takes into account one or more of the issues discussed above, as well as possibly other issues.

### SUMMARY

The illustrative embodiments of the present disclosure provide a method of using a configuration software part for an aircraft. A processor unit on the aircraft identifies software parts for the aircraft from a list of approved software parts for an approved software configuration for the aircraft in the configuration software part. The approved software configuration for the aircraft is identified in the configuration software part and the configuration software part is stored on the aircraft. The processor unit on the aircraft determines whether the software parts identified in the configuration software part are on the aircraft.

The illustrative embodiments of the present disclosure also provide an apparatus comprising a storage device on an aircraft, a configuration software part for the aircraft, and a configuration manager on the aircraft. The configuration software part for the aircraft is stored in the storage device on the aircraft. The configuration software part identifies an approved software configuration for the aircraft and comprises a list of approved software parts for the approved software configuration for the aircraft. The configuration manager on the aircraft is configured to identify software parts from the list of approved software parts in the configuration software part stored in the storage device on the aircraft and determine whether the software parts identified in the list of approved software parts in the configuration software part are on the aircraft.

The illustrative embodiments of the present disclosure also provide a method of providing a configuration software part for an aircraft. A processor unit receives, from a manufacturer of the aircraft, a manufacturer identification certificate, information identifying an approved manufacturer software configuration for the aircraft, a list of approved manufacturer software parts for the aircraft for the approved manufacturer software configuration, and cryptographic values for the approved manufacturer software parts. The processor unit also receives, from an operator of the aircraft, an operator identification certificate, information identifying an approved operator software configuration for the aircraft, a list of approved operator software parts for the aircraft for the approved operator software configuration, and cryptographic values for the approved operator software parts. The processor unit combines the manufacturer identification certificate, the information identifying the approved manufacturer software configuration for the aircraft, the list of approved manufacturer software parts for the approved manufacturer software configuration, the cryptographic values for the approved manufacturer software parts, the operator identification certificate, the information identifying the approved operator software configuration for the aircraft, the list of approved operator software parts for the approved operator software configuration, and the cryptographic values for the approved operator software parts to form the configuration software part for the aircraft. The configuration software part is provided for delivery to the aircraft by the processor unit.

The features, functions, and benefits can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives, and benefits thereof, will best be understood by reference to the following detailed description of illustrative embodiments of the present disclosure when read in conjunction with the accompanying drawings, wherein:

FIG. 1 is an illustration of a block diagram of an aircraft configuration and software part management environment in accordance with an illustrative embodiment;

FIG. 2 is an illustration of a block diagram of a configuration software part in accordance with an illustrative embodiment;

FIG. 3 is an illustration of a current configuration software part and a previous configuration software part on an aircraft in accordance with an illustrative embodiment;

FIG. 4 is an illustration of a block diagram of another configuration software part in accordance with an illustrative embodiment;

FIG. 5 is an illustration of a block diagram of yet another configuration software part in accordance with an illustrative embodiment;

FIG. 6 is an illustration of information flow for the generation and use of a configuration software part in accordance with an illustrative embodiment;

FIG. 7 is an illustration of a flowchart of a process for generating a configuration software part in accordance with an illustrative embodiment;

FIG. 8 is an illustration of a flowchart of an offboard process for managing software parts for an aircraft using a configuration software part in accordance with an illustrative embodiment;

FIG. 9 is an illustration of a flowchart of a process for loading a configuration software part on an aircraft in accordance with an illustrative embodiment;

FIG. 10 is an illustration of a flowchart of an onboard process for managing software parts for changing a configuration of an aircraft using a configuration software part in accordance with an illustrative embodiment;

FIG. 11 is an illustration of a flowchart of a process for determining whether the software configuration of an aircraft is approved using a configuration software part in accordance with an illustrative embodiment;

FIG. 12 is an illustration of a flowchart of a process for handling a software part received by an aircraft using a configuration software part in accordance with an illustrative embodiment;

FIG. 13 is an illustration of a flowchart of a process for removing unneeded software parts from an aircraft using a configuration software part in accordance with an illustrative embodiment; and

FIG. 14 is an illustration of block diagram of a data processing system in accordance with an illustrative embodiment.

### DETAILED DESCRIPTION

The different illustrative embodiments recognize and take into account a number of different considerations. “A number,” as used herein with reference to items, means one or more items. For example, “a number of different considerations” are one or more different considerations.

The different illustrative embodiments recognize and take into account that current configuration and software part management processes are substantially manual. For example, determining whether the software configuration of an aircraft matches an approved software configuration is currently done manually. There is currently no automatic checking of consistency between software parts on an aircraft. Currently, software parts to be loaded on an aircraft are manually selected and unneeded software parts are removed from the aircraft manually.

The different illustrative embodiments also recognize and take into account that the number of software parts on an aircraft is increasing as aircraft become more electronically enabled. Therefore, the tasks of configuration and software part management are increasing in complexity and current manual processes for configuration and software part management are increasingly inadequate.

The different illustrative embodiments recognize and take into account that continued integrity checking of software parts on an aircraft is currently done with specialized single function tables or is not done at all. Furthermore, current systems and methods for integrity checking of software parts may be based on a one size fits all model in which all software parts are treated equally without regard to criticality or certification status.

The different illustrative embodiments recognize and take into account that, currently, integrity checking of software parts is completely unrelated to maintaining the conformity of the software configuration of an aircraft with an approved configuration. For example, current systems and methods allow a software part to be loaded on an aircraft when an integrity check determines that the software part is from a trusted source and has not been corrupted. Current systems and methods do not recognize whether the software part is not included in an approved software configuration for the aircraft and thus should not be loaded on the aircraft.

The different illustrative embodiments recognize and take into account the dependency between attaining conformity of the software configuration of an aircraft to an approved software configuration and the management of software parts for the aircraft. The different illustrative embodiments use a configuration software part for an aircraft to improve both software configuration management and software part management.

A configuration software part in accordance with an illustrative embodiment may include information defining a number of approved software configurations for an aircraft. The configuration software part may include lists of approved software parts for each of the approved software configurations for the aircraft. The configuration software part also may include configuration rules defining the conditions under which each of the approved software configurations may be used for the aircraft. The configuration software part may include separate portions for approved manufacturer configurations and approved operator configurations.

A configuration software part in accordance with an illustrative embodiment may be loaded on an aircraft and made a part of the software configuration of the aircraft in the same manner as other software parts for the aircraft. An approved software configuration identified in the configuration software part loaded on an aircraft may be different from the current software configuration of the aircraft. In this case, the configuration software part may be used to change the software configuration of the aircraft to match the approved software configuration in a more efficient and automated manner. For example, the configuration software part may be used to identify and obtain approved software parts that must be loaded on the aircraft in order for the software configuration of the aircraft to match the approved software configuration identified in the configuration software part.

A configuration software part in accordance with an illustrative embodiment may be used to provide improved and automated management of the software configuration of an aircraft and of the software parts on the aircraft. For example, a configuration software part in accordance with an illustrative embodiment may be used to determine whether the current software configuration of the aircraft matches an approved software configuration identified in the configuration software part. The configuration software part may be used to improve integrity checking of software parts by preventing software parts that are not included in an approved configuration from being loaded on the aircraft, even when a conventional integrity check determines that the software part is from a trusted source and is not corrupted. The configuration software part also may be used to identify software parts on the aircraft that are not included in an approved software configuration and to remove such unneeded software parts from the aircraft.

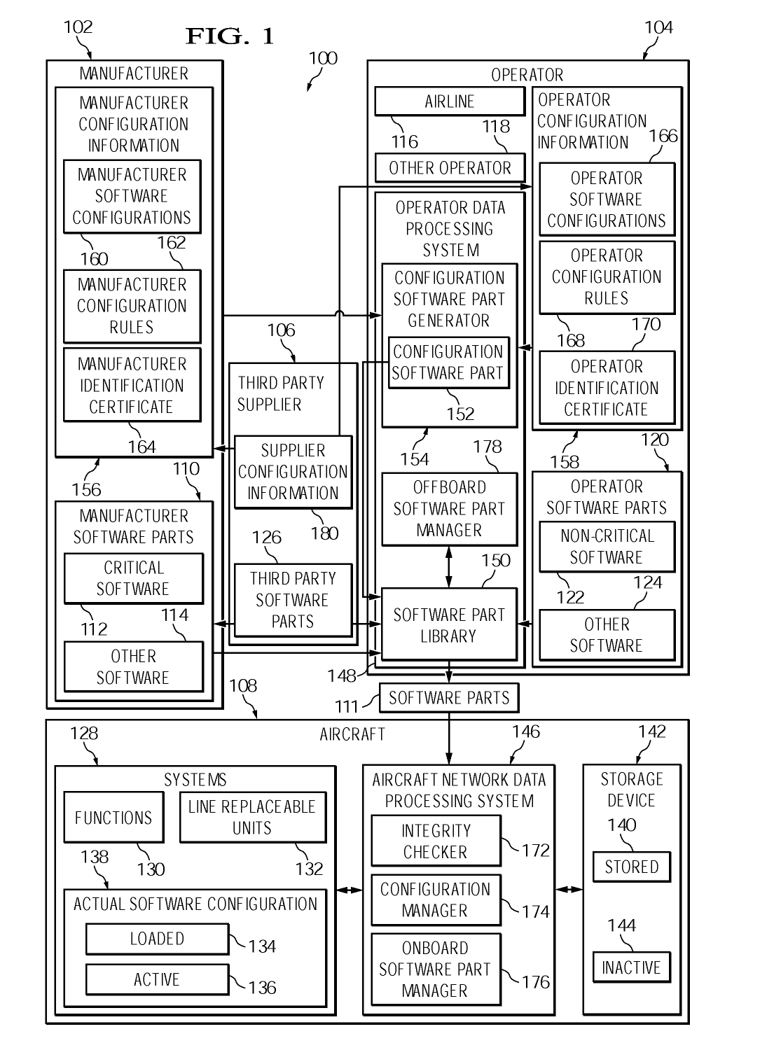

Turning now to FIG. 1, an illustration of a block diagram of an aircraft configuration and software part management environment is depicted in accordance with an illustrative embodiment. Aircraft configuration and software part management environment 100 may include manufacturer 102, operator 104, third party supplier 106, and aircraft 108.

Manufacturer 102 may be any appropriate entity that has the responsibility for building aircraft 108 and providing aircraft 108 to operator 104. Manufacturer 102 may provide manufacturer software parts 110 for use on aircraft 108. Manufacturer software parts 110 are an example of software parts 111 for aircraft 108.

For example, without limitation, manufacturer software parts 110 may include critical software 112. Critical software 112 may include software that is required for or otherwise may affect the safe operation of aircraft 108. For example, without limitation, critical software 112 may include software that affects the requirements for airworthiness of an aircraft as set forth in Federal Aviation Regulations, Part 25, or other rules and regulations in the United States of America and other countries. Manufacturer software parts 110 may include other software 114. Other software 114 may include software other than critical software 112. For example, without limitation, other software 114 may include non-critical software.

Operator 104 may be any appropriate entity that is responsible for the operation of aircraft 108. For example, operator 104 may be airline 116 or other operator 118. For example, without limitation, other operator 118 may be a military organization or any other appropriate government or private entity or any appropriate combination of entities.

Operator 104 may provide operator software parts 120 for use on aircraft 108. Operator software parts 120 are another example of software parts 111 for aircraft 108. For example, without limitation, operator software parts 120 may include non-critical software 122. Non-critical software 122 may include software that is desirable for the efficient operation of aircraft 108, for the comfort of the passengers on aircraft 108, or for any other purpose or combination of purposes. However, non-critical software 122 does not affect the safe operation of aircraft 108. For example, without limitation, non-critical software 122 may include software that affects the operating requirements for an aircraft as set forth in Federal Aviation Regulations, Part 121, or in other rules and regulations in the United States of America and other countries. Operator software parts 120 also may include other software 124.

In this illustrative example, third party supplier 106 may be an entity other than manufacturer 102 and operator 104 that provides third party software parts 126 for use on aircraft 108. Third party software parts 126 are another example of software parts 111 for aircraft 108.

Manufacturer 102 may or may not produce all of manufacturer software parts 110 provided by manufacturer 102 for use on aircraft 108. For example, a portion of manufacturer software parts 110 may be produced by third party supplier 106 for manufacturer 102 or otherwise obtained by manufacturer 102 from third party supplier 106. In this case, manufacturer software parts 110 may include third party software parts 126.

Operator 104 may or may not produce all of operator software parts 120 provided by operator 104 for use on aircraft 108. For example, a portion of operator software parts 120 may be produced by third party supplier 106 for operator 104 or otherwise obtained by operator 104 from third party supplier 106. In this case, operator software parts 120 may include third party software parts 126.

Aircraft 108 may be a commercial passenger aircraft, a cargo aircraft, a private or personal aviation aircraft, a military aircraft, or any other appropriate type of aircraft that may be used for any appropriate purpose. Aircraft 108 may include various systems 128 for performing various functions 130 on aircraft 108. For example, without limitation, systems 128 may include line-replaceable units 132.

Software parts 111 may be loaded 134 on systems 128 to implement functions 130 performed by systems 128. Software parts 111 that are loaded 134 on systems 128 also may be referred to as active 136. Software parts 111 that are loaded 134 and active 136 on systems 128 comprise actual software configuration 138 of aircraft 108.

Software parts 111 also may be stored 140 in storage device 142 on aircraft 108. Storage device 142 may include any number of appropriate hardware devices for storing software parts 111 on aircraft 108. Storage device 142 also may be referred to as a mass storage device. For example, software parts 111 may be stored 140 in storage device 142 before being loaded 134 on systems 128. Software parts 111 that are stored 140 in storage device 142 on aircraft 108 also may be referred to as inactive 144. Software parts 111 that are stored 140 in storage device 142 and inactive 144 may not be considered to be part of actual software configuration 138 of aircraft 108.

Communications between and among systems 128 and storage device 142 on aircraft 108 may be provided by aircraft network data processing system 146. For example, without limitation, aircraft network data processing system 146 on aircraft 108 may be configured to receive software parts 111, store software parts 111 in storage device 142, and load software parts 111 from storage device 142 on systems 128.

Software parts 111 may be loaded on aircraft 108 by manufacturer 102 before aircraft 108 is delivered to operator 104. Software parts 111 also may be loaded on aircraft 108 after delivery to operator 104. For example, without limitation, software parts 111 may be loaded on aircraft 108 to replace or update software parts 111 that were originally loaded on aircraft 108 by manufacturer 102.

Software parts 111 may be loaded on aircraft 108 by operator 104 as part of the process of maintaining aircraft 108 by operator 104. Alternatively, or in addition, software parts 111 may be loaded on aircraft 108 by another appropriate entity. For example, without limitation, software parts 111 may be loaded on aircraft 108 by a maintenance entity or another entity that maintains aircraft 108 for operator 104.

For example, without limitation, operator data processing system 148 may be configured to receive manufacturer software parts 110 from manufacturer 102, operator software parts 120 from operator 104, and third party software parts 126 from third party supplier 106, and to save manufacturer software parts 110, operator software parts 120, and third party software parts 126 in software part library 150. Operator data processing system 148 may include any appropriate data processing system operated by, for, or on behalf of operator 104 to perform a number of functions of operator data processing system 148 as described herein. Software part library 150 may include any number of appropriate storage devices for storing software parts 111 at a location that is not on aircraft 108. Software parts 111 in software part library 150 may be readily available for delivery to aircraft 108. For example, without limitation, operator data processing system 148 may be configured to deliver software parts 111 from software part library 150 to aircraft 108 in any appropriate manner.

Any appropriate apparatus and method may be used to deliver software parts 111 to aircraft 108 from software part library 150 or another location. For example, without limitation, a human technician may use a maintenance device to retrieve software parts 111 for aircraft 108 from software part library 150, another location, or a combination of locations. For example, the maintenance device may be a laptop computer or another appropriate portable data processing device. The retrieved software parts 111 may be stored on the maintenance device and the maintenance device then may be moved to aircraft 108. A human technician may connect the maintenance device to aircraft network data processing system 146 on aircraft 108 via an appropriate wired or wireless connection. Software parts 111 then may be delivered to aircraft 108 by copying or otherwise moving software parts 111 from the maintenance device to aircraft network data processing system 146 on aircraft 108.

Alternatively, or in addition, software parts 111 may be delivered to aircraft 108 without physically transporting software parts 111 to aircraft 108 on a maintenance device. For example, without limitation, software parts 111 may be delivered to aircraft 108 from software part library 150 via an appropriate wired or wireless connection between operator data processing system 148 and aircraft network data processing system 146 on aircraft 108.

In accordance with an illustrative embodiment, actual software configuration 138 of aircraft 108 and software parts 111 for aircraft 108 may be managed in an effective and efficient manner using configuration software part 152. Configuration software part 152 may be generated by or for operator 104 or any other entity or group of entities responsible for managing actual software configuration 138 of aircraft 108 and software parts 111 for use on aircraft 108. Configuration software part 152 may be generated by configuration software part generator 154. For example, without limitation, configuration software part generator 154 may be implemented in operator data processing system 148 or in another appropriate manner.

Configuration software part 152 may be saved in software part library 150 along with other software parts 111 for aircraft 108. Configuration software part 152 may be delivered to aircraft 108 and loaded 134 on aircraft 108 in the same manner as other software parts 111 for aircraft 108. Configuration software part 152 is part of actual software configuration 138 of aircraft 108 when configuration software part 152 is loaded 134 on aircraft 108.

Configuration software part 152 may include information for determining the integrity of configuration software part 152, information identifying a number of allowed software configurations for aircraft 108, and configuration rules for determining which of the number of allowed software configurations should be used for aircraft 108 for particular conditions. Configuration software part 152 may include a list of approved software parts for each of the approved software configurations identified in configuration software part 152. In the present application, including in the claims, a software configuration or a software part may be considered approved when the software configuration or software part is approved for use on an aircraft by an entity that has the authority to approve software configurations and software parts for the aircraft.

Configuration software part 152 may identify separate software configurations and software parts for aircraft 108 that are approved by manufacturer 102 of aircraft 108 and operator 104 of aircraft 108. For example, without limitation, configuration software part 152 may be generated by combining manufacturer configuration information 156 from manufacturer 102 and operator configuration information 158 from operator 104.

Manufacturer configuration information 156 may include information identifying manufacturer software configurations 160 for aircraft 108 and manufacturer configuration rules 162. Manufacturer software configurations 160 may comprise configurations of manufacturer software parts 110 that are approved by manufacturer 102 for aircraft 108. Manufacturer configuration rules 162 may include information for determining which of manufacturer software configurations 160 are approved for aircraft 108 under various conditions.

Manufacturer configuration information 156 also may include manufacturer identification certificate 164. For example, manufacturer identification certificate 164 may be a public key certificate or a digital certificate for manufacturer configuration information 156. Manufacturer identification certificate 164 may be used to verify that manufacturer configuration information 156 is from manufacturer 102 and has not been changed from its original form.

Operator configuration information 158 may include information identifying operator software configurations 166 for aircraft 108 and operator configuration rules 168. Operator software configurations 166 may comprise configurations of operator software parts 120 that are approved by operator 104 for aircraft 108. Operator configuration rules 168 may include information for determining which of operator software configurations 166 are approved for aircraft 108 under various conditions.

Operator configuration information 158 also may include operator identification certificate 170. For example, operator identification certificate 170 may be a public key certificate or a digital certificate for operator configuration information 158. Operator identification certificate 170 may be used to verify that operator configuration information 158 is from operator 104 and has not been changed from its original form.

Operator data processing system 148 may be configured to receive manufacturer configuration information 156 from manufacturer 102 and operator configuration information 158 from operator 104 and to provide manufacturer configuration information 156 to configuration software part generator 154 for use in generating configuration software part 152. Configuration software part generator 154 may be configured to combine manufacturer configuration information 156 and operator configuration information 158 to generate configuration software part 152.

Configuration software part 152 may be used for configuration and software part management on aircraft 108 by integrity checker 172, configuration manager 174, and onboard software part manager 176. Integrity checker 172, configuration manager 174, and onboard software part manager 176 may be implemented in hardware or in a combination of hardware and software on aircraft 108. For example, integrity checker 172, configuration manager 174, and onboard software part manager 176 may be implemented on aircraft network data processing system 146 on aircraft 108.

Integrity checker 172 on aircraft 108 may be configured to validate the integrity of software parts 111 before software parts 111 are loaded 134 on aircraft 108. Integrity checker 172 also may be configured to validate the integrity of configuration software part 152 before configuration software part 152 is used for configuration and software part management on aircraft 108. Configuration software part 152 may be used by integrity checker 172 to prevent software parts 111 that are not for an approved software configuration from being loaded 134 on aircraft 108, even when such software parts pass the other integrity checks performed by integrity checker 172.

Configuration manager 174 on aircraft 108 may be configured to use configuration software part 152 to manage the software configuration of aircraft 108. For example, configuration manager 174 may be configured to use configuration software part 152 to determine whether actual software configuration 138 of aircraft 108 matches an approved configuration for aircraft 108 identified in configuration software part 152.

Onboard software part manager 176 on aircraft 108 may be configured to use configuration software part 152 to manage software parts 111 on aircraft 108. For example, onboard software part manager 176 may be configured to determine whether approved software parts identified in configuration software part 152 are on aircraft 108 and to obtain approved software parts that are not on aircraft 108 for loading on aircraft 108. Onboard software part manager 176 also may be configured to remove software parts 111 from systems 128 and storage device 142 on aircraft 108 when such software parts 111 are not identified as approved software parts for an approved software configuration in configuration software part 152.

Configuration software part 152 also may be used to manage software parts 111 before software parts 111 are delivered to aircraft 108. For example, offboard software part manager 178 may be configured to determine whether approved software parts identified in configuration software part 152 for aircraft 108 are available in software part library 150 for loading on aircraft 108. Offboard software part manager 178 may be configured to obtain approved software parts that are not in software part library 150 for loading on aircraft 108.

The illustration of FIG. 1 is not meant to imply physical or architectural limitations to the manner in which different illustrative embodiments may be implemented. Other components in addition to and/or in place of the ones illustrated may be used. Some components may be unnecessary in some illustrative embodiments. Also, the blocks are presented to illustrate some functional components. One or more of these blocks may be combined and/or divided into different blocks when implemented in different illustrative embodiments.

For example, configuration software part 152 may include configuration information other than or in addition to manufacturer configuration information 156 and operator configuration information 158. For example, manufacturer configuration information 156, operator configuration information 158, or both, as included in configuration software part 152 may include supplier configuration information 180 provided by third party supplier 106.

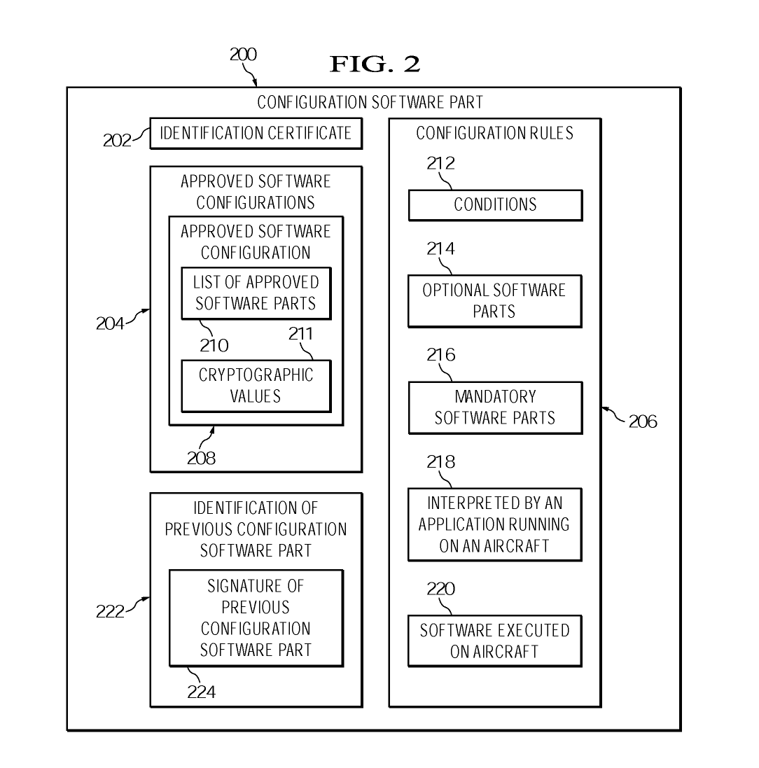

Turning to FIG. 2, an illustration of a block diagram of a configuration software part is depicted in accordance with an illustrative embodiment. Configuration software part 200 is an example of one implementation of configuration software part 152 in FIG. 1.

Configuration software part 200 may include identification certificate 202, information identifying approved software configurations 204 for an aircraft, and configuration rules 206. Identification certificate 202 includes information that may be used to verify that configuration software part 200 is from a trusted source. Each approved software configuration 208 in approved software configurations 204 may include a list of approved software parts 210 for approved software configuration 208 and cryptographic values 211 for the approved software parts. Cryptographic values 211 may include any appropriate values for validating the integrity of the approved software parts. For example, without limitation, cryptographic values 211 may include digital certificates or other appropriate information for validating the integrity of the approved software parts.

Configuration rules 206 may include information for determining which of approved software configurations 204 should be used for an aircraft for particular conditions 212. For example, configuration rules 206 may identify optional software parts 214 and mandatory software parts 216 for approved software configurations 204 for particular conditions 212. Configuration rules 206 may be implemented in any appropriate manner. For example, without limitation, configuration rules 206 may be implemented in an appropriate manner so as to be interpreted by an application running on an aircraft 218. Alternatively, configuration rules 206 may be implemented in software that is executed on the aircraft 220.

Configuration software part 200 also may include identification of previous configuration software part 222. For example, without limitation, identification of previous configuration software part 222 may include signature of previous configuration software part 224 with identification certificate 202 for configuration software part 200.

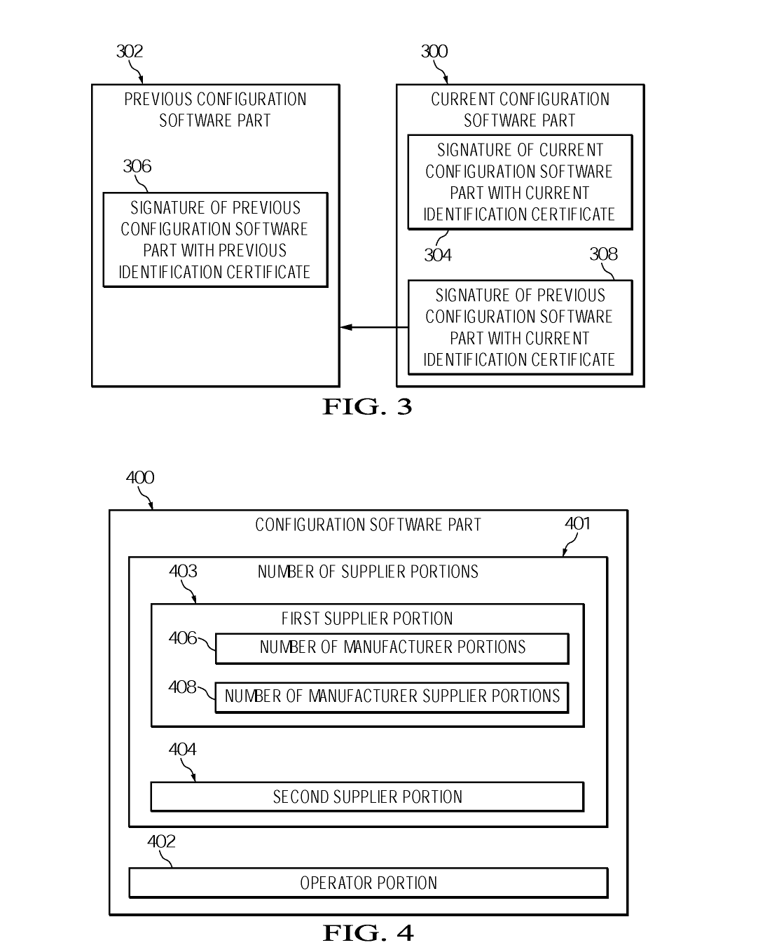

Turning to FIG. 3, an illustration of a current configuration software part and a previous configuration software part on an aircraft is depicted in accordance with an illustrative embodiment. Current configuration software part 300 and previous configuration software part 302 may be examples of configuration software part 200 in FIG. 2.

Current configuration software part 300 may identify the current software configuration of an aircraft. Current configuration software part 300 may include signature of current configuration software part with current identification certificate 304.

Previous configuration software part 302 may identify one or more previous software configurations of the aircraft. Previous configuration software part 302 may include signature of previous configuration software part with previous identification certificate 306.

Current configuration software part 300 may supersede previous configuration software part 302 to define the current software configuration of the aircraft. In some cases, however, it may be desirable to revert to the previous software configuration of the aircraft as defined by previous configuration software part 302. For example, it may be desirable to revert to a previous software configuration when the current software configuration as defined by current configuration software part 300 is not operating in a desired manner or for another appropriate reason.

The previous identification certificate associated with previous configuration software part 302 may expire or otherwise become invalid. The identification certificate associated with previous configuration software part 302 may be updated by including signature of previous configuration software part with current identification certificate 308 in current configuration software part 300. The current identification certificate then may be attached to previous configuration software part 302 for use in the event of reversion to the previous software configuration defined by previous configuration software part 302.

Turning to FIG. 4, an illustration of a block diagram of another configuration software part is depicted in accordance with an illustrative embodiment. Configuration software part 400 may be an example of an implementation of configuration software part 152 in FIG. 1.

Configuration software part 400 may include a number of portions for various software configurations defined by various suppliers and by an operator of the aircraft. For example, configuration software part 400 may include number of supplier portions 401 and operator portion 402. Number of supplier portions 401 may include one or more supplier portions. For example, without limitation, number of supplier portions 401 may include first supplier portion 403 and second supplier portion 404. A configuration software part in accordance with an illustrative embodiment may include more than two supplier portions.

First supplier portion 403, second supplier portion 404, or both, may comprise a number of supplier portions in a nested manner. For example, without limitation, first supplier portion 403 may include number of manufacturer portions 406 and number of manufacturer supplier portions 408.

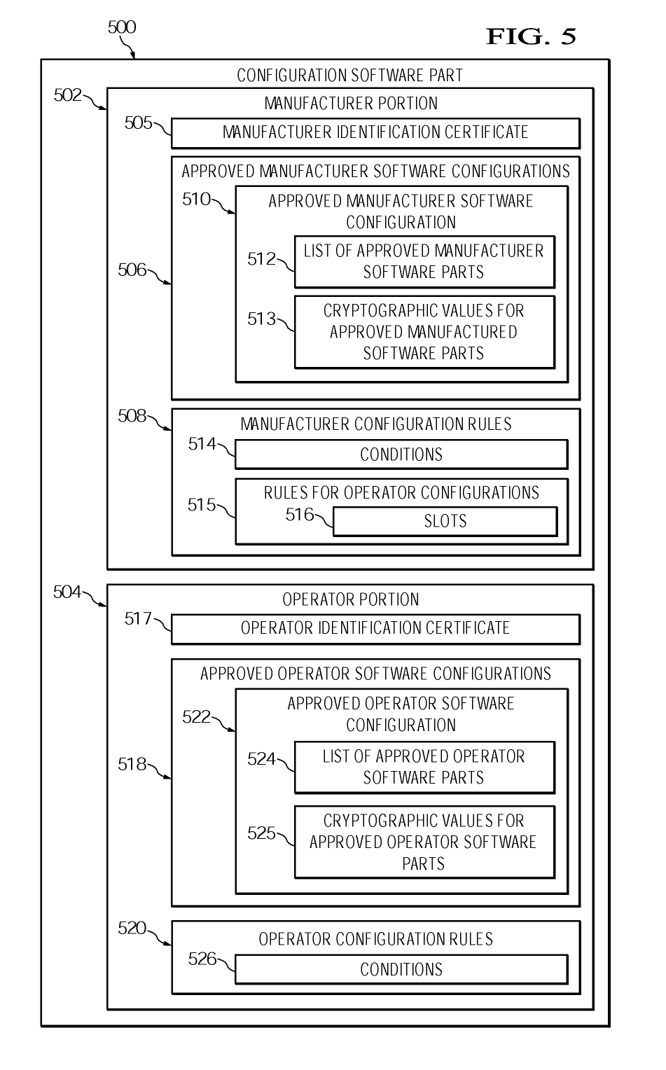

Turning to FIG. 5, an illustration of a block diagram of yet another configuration software part is depicted in accordance with an illustrative embodiment. Configuration software part 500 is another example of configuration software part 152 in FIG. 1. Configuration software part 500 may be an example of configuration software part 400 in FIG. 4. Configuration software part 500 may include manufacturer portion 502 and operator portion 504.

Manufacturer portion 502 may include manufacturer identification certificate 505, information identifying approved manufacturer software configurations 506 for an aircraft, and manufacturer configuration rules 508. Each approved manufacturer software configuration 510 in approved manufacturer software configurations 506 may include list of approved manufacturer software parts 512. Approved manufacturer software configuration 510 also may include cryptographic values for approved manufacturer software parts 513.

Manufacturer configuration rules 508 may include information for determining which of approved manufacturer software configurations 506 are approved for the aircraft under various conditions 514. Manufacturer configuration rules 508 also may include rules for operator configurations 515. For example, without limitation, rules for operator configurations 515 may identify slots 516 where an aircraft operator may place some software parts of their own. Manufacturer configuration rules 508 may identify such operator software parts as optional or required.

Operator portion 504 may include operator identification certificate 517, information identifying approved operator software configurations 518 for an aircraft, and operator configuration rules 520. Each approved operator software configuration 522 in approved operator software configurations 518 may include list of approved operator software parts 524 and cryptographic values for approved operator software parts 525. Operator configuration rules 520 may include information for determining which of approved operator software configurations 518 are approved for the aircraft under various conditions 526.

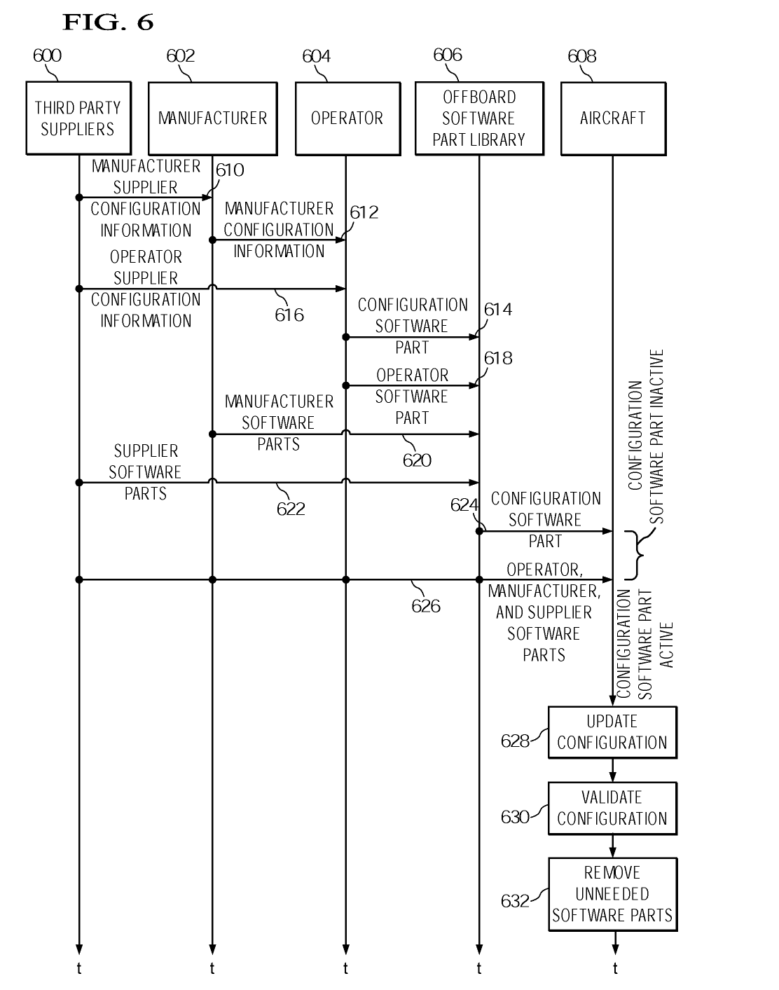

Turning to FIG. 6, an illustration of information flow for the generation and use of a configuration software part is depicted in accordance with an illustrative embodiment. An example of information flow between third party suppliers 600, manufacturer 602, operator 604, offboard software part library 606, and aircraft 608 is depicted in accordance with an illustrative embodiment.

Manufacturer supplier configuration information 610 may be provided from third party suppliers 600 to manufacturer 602. Manufacturer supplier configuration information 610 may be included in manufacturer configuration information 612 by manufacturer 602. Manufacturer configuration information 612 then may be provided from manufacturer 602 to operator 604. Manufacturer configuration information 612 may be combined with operator configuration information by operator 604 to generate configuration software part 614. The operator configuration information included in configuration software part 614 may include operator supplier configuration information 616 from third party suppliers 600.

Configuration software part 614 may be provided from operator 604 to offboard software part library 606. Configuration software part 614 may be used at offboard software part library 606 to determine whether operator software parts 618, manufacturer software parts 620, and supplier software parts 622 as identified in configuration software part 614 are available in offboard software part library 606. Operator software parts 618, manufacturer software parts 620, and supplier software parts 622 identified in configuration software part 614 may be obtained and stored in offboard software part library 606 before configuration software part 624 is provided to aircraft 608.

Configuration software part 624 may be inactive on aircraft 608 until it is determined that operator, manufacturer, and supplier software parts 626 identified in configuration software part 624 also are on aircraft 608. Then configuration software part 624 may be made active. Configuration software part 624 on aircraft 608 then may be used to update configuration 628 of aircraft 608, validate configuration 630 of aircraft 608, and remove unneeded software parts 632 from aircraft 608.

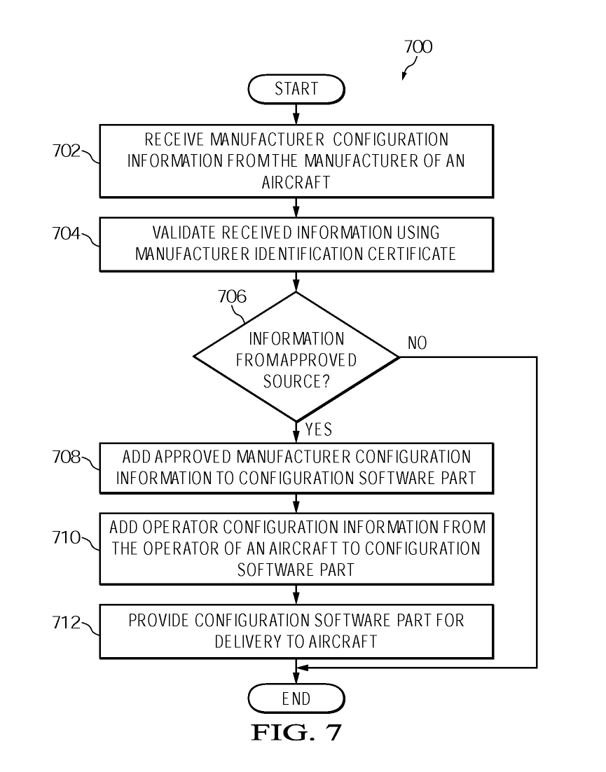

Turning to FIG. 7, an illustration of a flowchart of a process for generating a configuration software part is depicted in accordance with an illustrative embodiment. For example, process 700 may be implemented in configuration software part generator 154 to generate configuration software part 152 in FIG. 1.

Process 700 may begin by receiving manufacturer configuration information from the manufacturer of an aircraft (operation 702). The received manufacturer configuration information may be validated using a manufacturer identification certificate (operation 704). The validation may be performed to determine whether the manufacturer identification information is from an approved source (operation 706). If the information is determined not to be from an approved source at operation 706, the process may terminate. If the information is from an approved source, the manufacturer configuration information may be added to the configuration software part (operation 708). Operator configuration information from an operator of the aircraft also may be added to the configuration software part (operation 710). The configuration software part then may be provided for delivery to an aircraft (operation 712), with the process terminating thereafter. A process similar to process 700 may be used to generate the manufacturer portion of a configuration software part using supplier configuration information provided by a third party supplier.

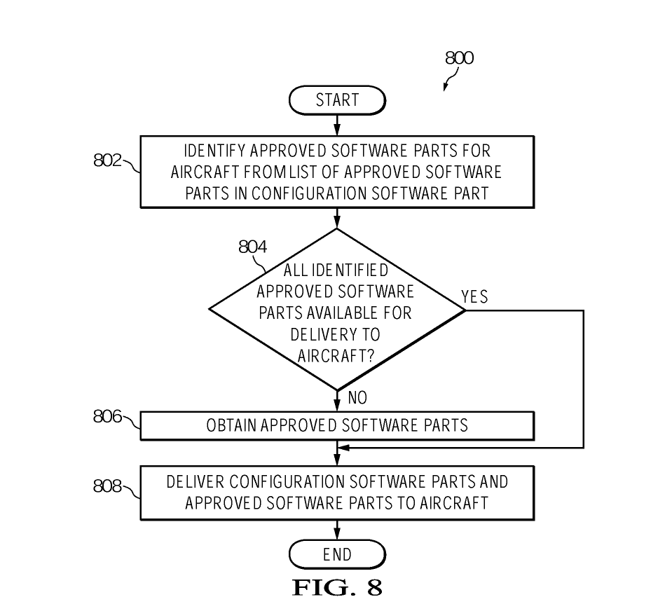

Turning to FIG. 8, an illustration of a flowchart of an offboard process for managing software parts for an aircraft using a configuration software part is depicted in accordance with an illustrative embodiment. For example, process 800 may be implemented in offboard software part manager 178 in FIG. 1.

Process 800 may begin by identifying approved software parts for an aircraft from a list of approved software parts in a configuration software part (operation 802). It then may be determined whether all approved software parts identified in the configuration software part are available for delivery to the aircraft (operation 804). If not, any approved software parts that are not available are obtained (operation 806). If it is determined at operation 804 that all approved software parts identified in the configuration software part are available, or after any approved software parts that are not available are obtained at operation 806, the configuration software parts and approved software parts then may be delivered to the aircraft (operation 808), with the process terminating thereafter. In this example, the configuration software part is not delivered to the aircraft until all of the software parts for a valid configuration for the aircraft are available.

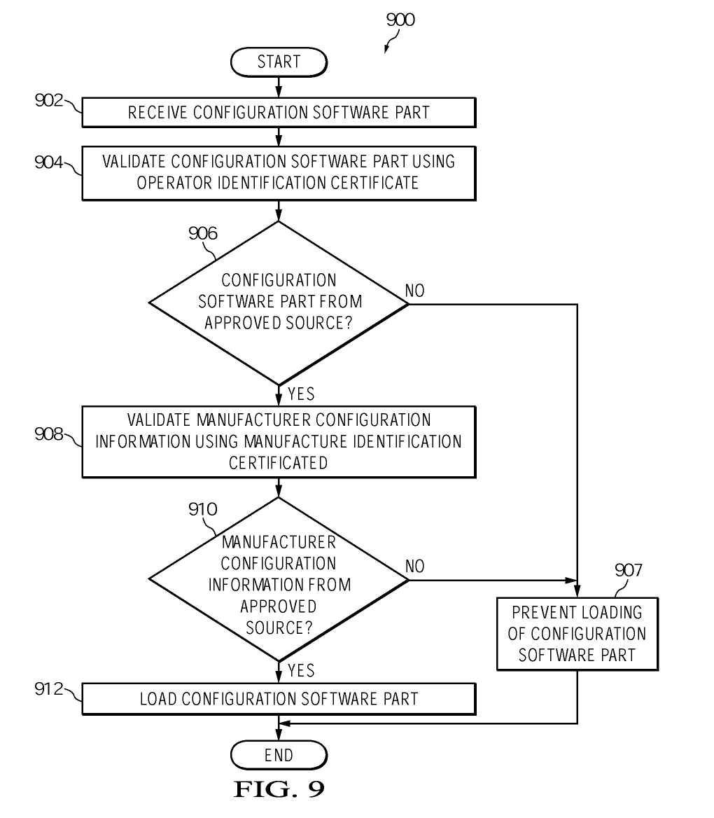

Turning to FIG. 9, an illustration of a flowchart of a process for loading a configuration software part on an aircraft is depicted in accordance with an illustrative embodiment. For example, process 900 may be performed by integrity checker 172 and configuration manager 174 on aircraft 108 in FIG. 1.

Process 900 begins with receiving a configuration software part on an aircraft (operation 902). The configuration software part then is validated using an identification certificate for the configuration software part that is received with the configuration software part (operation 904). For example, the identification certificate may be an operator identification certificate that is provided for the configuration software part by an operator of the aircraft. In this case, the operator identification certificate may be provided as an identification certificate for the configuration software part as a whole or for an operator portion of the configuration software part. In addition, or alternatively, a manufacturer certificate may be used to validate the configuration software part. For example, the manufacturer certificate may be provided by a manufacturer of the aircraft for a manufacturer portion of the configuration software part.

The validation of operation 904 is performed to determine whether the configuration software part is from an approved source (operation 906). If the configuration software part is not from an approved source, loading of the configuration software part on the aircraft is prevented (operation 907), with the process terminating thereafter. Otherwise, manufacturer configuration information in the configuration software part is validated (operation 908). Operation 908 is performed to determine whether the manufacturer configuration information is from an approved source (operation 910). If not, loading of the configuration software part on the aircraft is prevented at operation 907, with the process terminating thereafter. Otherwise, the configuration software part is loaded on the aircraft (operation 912), with the process terminating thereafter.

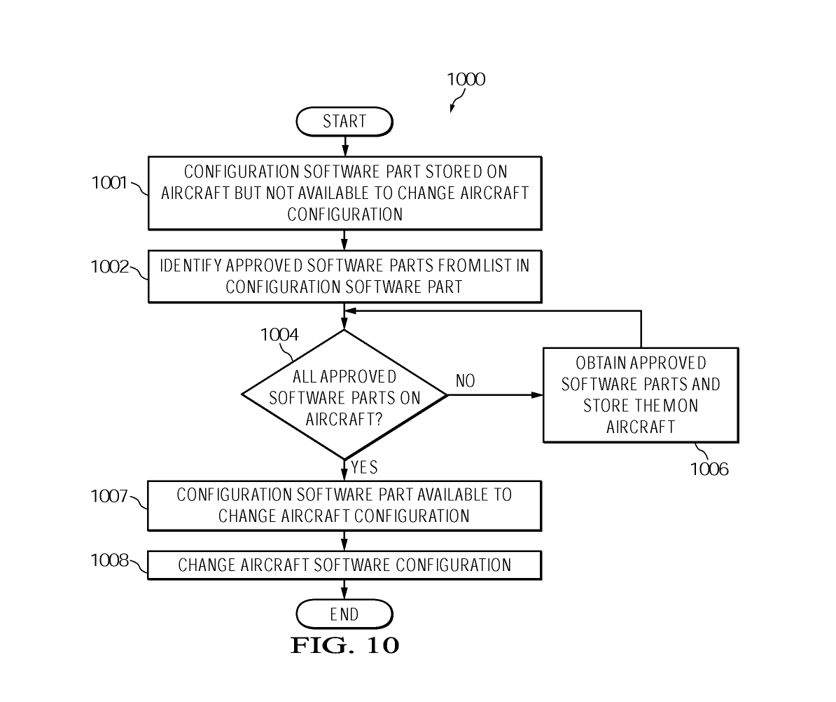

Turning to FIG. 10, an illustration of a flowchart of an onboard process for managing software parts for changing a configuration of an aircraft using a configuration software part is depicted in accordance with an illustrative embodiment. For example, process 1000 may be performed by onboard software part manager 176 and configuration manager 174 in FIG. 1.

Process 1000 begins with a configuration software part stored on an aircraft but not available to change the aircraft configuration (operation 1001). Approved software parts for an approved software configuration are identified from a list in the configuration software part and configuration rules in the configuration software part (operation 1002). It then may be determined whether all of the approved software parts are on the aircraft (operation 1004). If all of the approved software parts for the approved configuration are not on the aircraft, the approved software parts that are not on the aircraft are obtained and stored on the aircraft (operation 1006). Operations 1004 and 1006 may be repeated until it is determined that all approved software parts are on the aircraft. Then the configuration software part may be made available to change the configuration of the aircraft (operation 1007). The aircraft software configuration then may be changed to the configuration defined in the configuration software part (operation 1008), with the process terminating thereafter.

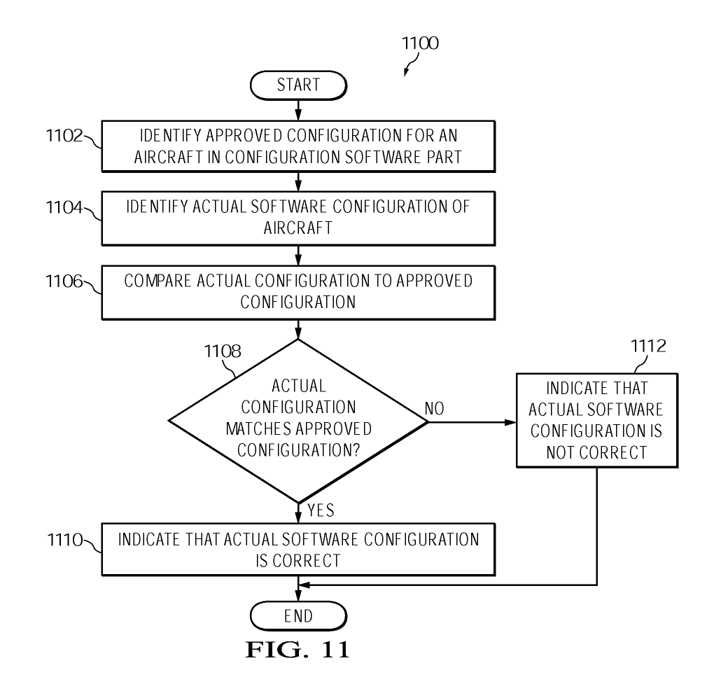

Turning to FIG. 11, an illustration of a flowchart of a process for determining whether the software configuration of an aircraft is approved using a configuration software part is depicted in accordance with an illustrative embodiment. For example, process 1100 may be performed by configuration manager 174 on aircraft 108 in FIG. 1.

Process 1100 begins by identifying an approved configuration for an aircraft in a configuration software part loaded on the aircraft (operation 1102). The actual software configuration of the aircraft also is identified (operation 1104). The actual software configuration of the aircraft is compared to the approved software configuration (operation 1106). Based on the comparison made in operation 1106, it is determined whether the actual software configuration of the aircraft matches the approved software configuration (operation 1108). An indication that the actual software configuration is correct is provided in response to a determination that the actual configuration matches the approved configuration (operation 1110), with the process terminating thereafter. Otherwise, an indication that the actual software configuration is not correct is provided (operation 1112), with the process terminating thereafter.

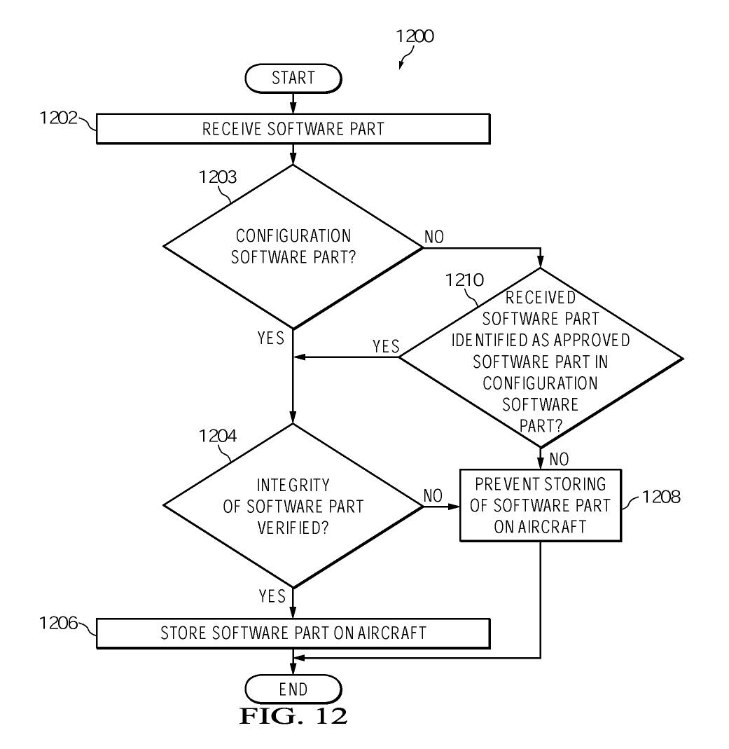

Turning to FIG. 12, an illustration of a flowchart of a process for handling a software part received by an aircraft using a configuration software part is depicted in accordance with an illustrative embodiment. For example, process 1200 may be performed by integrity checker 172 on aircraft 108 in FIG. 1.

Process 1200 begins with receiving a software part on an aircraft (operation 1202). It is determined whether the software part is a configuration software part (operation 1203). In response to a determination that the software part is a configuration software part, it is determined whether the integrity of the software part is verified (operation 1204). If the integrity of the software part is verified, the software part is stored on the aircraft (operation 1206), with the process terminating thereafter. Otherwise, the storing of the software part on the aircraft is prevented (operation 1208), with the process terminating thereafter.

If it is determined at operation 1203 that the software part is not a configuration software part, it is determined whether the received software part is identified as an approved software part in a configuration software part loaded on the aircraft (operation 1210). If the received software part is identified as an approved software part in the configuration software part, the integrity of the software part is verified at operation 1204 and stored at operation 1206 or prevented from being stored at operation 1208, as appropriate, with the process terminating thereafter. Otherwise, storing of the software part on the aircraft is prevented at operation 1208, with the process terminating thereafter.

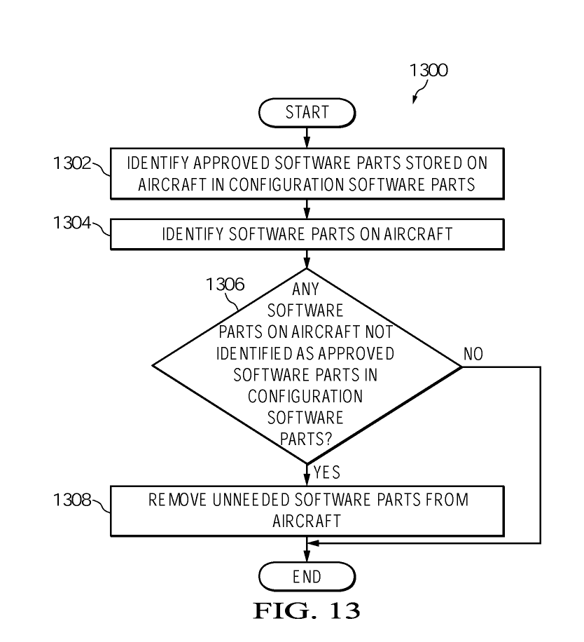

Turning to FIG. 13, an illustration of a flowchart of a process for removing unneeded software parts from an aircraft using a configuration software part is depicted in accordance with an illustrative embodiment. For example, process 1300 may be performed by onboard software part manager 176 on aircraft 108 in FIG. 1.

Process 1300 begins by identifying approved software parts in configuration software parts stored on the aircraft (operation 1302). All available configuration software parts on the aircraft may be used in operation 1302, not just the current active configuration software part. In this manner, software parts for various configurations may be retained on the aircraft. An appropriate policy may be implemented to identify how many or which previous configuration software parts may be kept on the aircraft. Software parts on the aircraft are then identified (operation 1304). It then is determined whether any software parts on the aircraft are not identified as approved software parts in the configuration software parts (operation 1306). Any software parts that are not identified in the configuration software part are not needed and are removed from the aircraft (operation 1308), with the process terminating thereafter.

The flowcharts and block diagrams in the different depicted embodiments illustrate the architecture, functionality, and operation of some possible implementations of apparatuses and methods in illustrative embodiments. In this regard, each block in the flowcharts or block diagrams may represent a module, segment, function, and/or a portion of an operation or step. For example, one or more of the blocks may be implemented as program code, in hardware, or a combination of program code and hardware. When implemented in hardware, the hardware may, for example, take the form of integrated circuits that are manufactured or configured to perform one or more operations in the flowcharts or block diagrams.

In some alternative implementations of an illustrative embodiment, the function or functions noted in the blocks may occur out of the order shown in the figures. For example, in some cases, two blocks shown in succession may be executed substantially concurrently, or the blocks may sometimes be performed in the reverse order, depending upon the functionality involved. Also, other blocks may be added in addition to the blocks illustrated in a flowchart or block diagram.

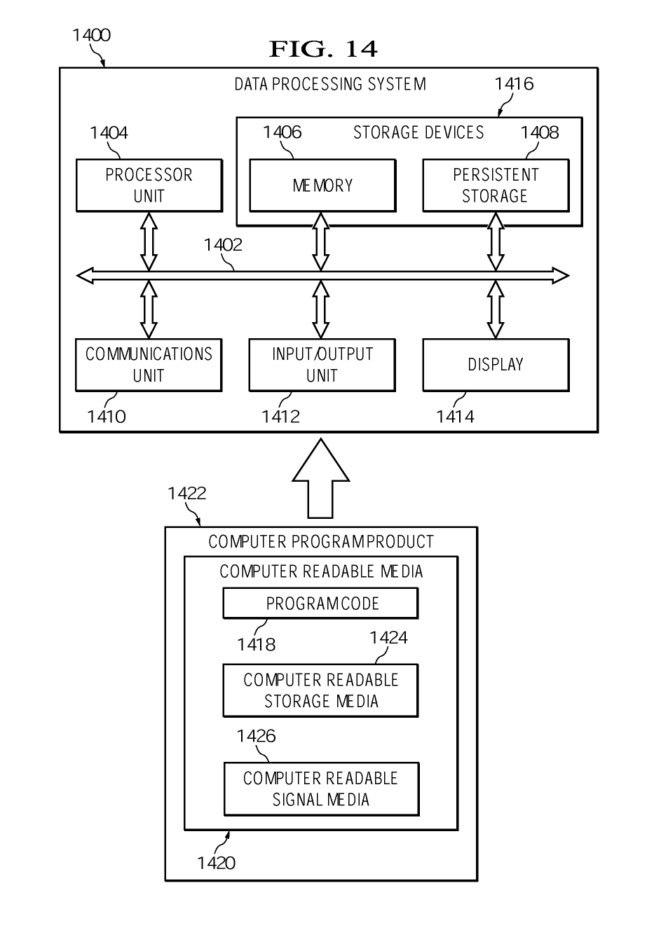

Turning to FIG. 14, an illustration of a block diagram of a data processing system is depicted in accordance with an illustrative embodiment. Data processing system 1400 may be an example of one implementation of aircraft network data processing system 146 on aircraft 108 in FIG. 1. Data processing system 1400 also may be an example of one implementation of operator data processing system 148 in FIG. 1.

In this illustrative example, data processing system 1400 includes communications fabric 1402. Communications fabric 1402 provides communications between processor unit 1404, memory 1406, persistent storage 1408, communications unit 1410, input/output (I/O) unit 1412, and display 1414.

Processor unit 1404 serves to execute instructions for software that may be loaded into memory 1406. Processor unit 1404 may be a number of processors, a multi-processor core, or some other type of processor, depending on the particular implementation. A number, as used herein with reference to an item, means one or more items. Further, processor unit 1404 may be implemented using a number of heterogeneous processor systems in which a main processor is present with secondary processors on a single chip. As another illustrative example, processor unit 1404 may be a symmetric multi-processor system containing multiple processors of the same type.

Memory 1406 and persistent storage 1408 are examples of storage devices 1416. A storage device is any piece of hardware that is capable of storing information, such as, for example, without limitation, data, program code in functional form, and/or other suitable information either on a temporary basis and/or a permanent basis. Storage devices 1416 may also be referred to as computer readable storage devices in these examples. Memory 1406, in these examples, may be, for example, a random access memory or any other suitable volatile or non-volatile storage device. Persistent storage 1408 may take various forms, depending on the particular implementation.

For example, persistent storage 1408 may contain one or more components or devices. For example, persistent storage 1408 may be a hard drive, a flash memory, a rewritable optical disk, a rewritable magnetic tape, or some combination of the above. The media used by persistent storage 1408 also may be removable. For example, a removable hard drive may be used for persistent storage 1408.

Communications unit 1410, in these examples, provides for communications with other data processing systems or devices. In these examples, communications unit 1410 is a network interface card. Communications unit 1410 may provide communications through the use of either or both physical and wireless communications links.

Input/output unit 1412 allows for input and output of data with other devices that may be connected to data processing system 1400. For example, input/output unit 1412 may provide a connection for user input through a keyboard, a mouse, and/or some other suitable input device. Further, input/output unit 1412 may send output to a printer. Display 1414 provides a mechanism to display information to a user.

Instructions for the operating system, applications, and/or programs may be located in storage devices 1416, which are in communication with processor unit 1404 through communications fabric 1402. In these illustrative examples, the instructions are in a functional form on persistent storage 1408. These instructions may be loaded into memory 1406 for execution by processor unit 1404. The processes of the different embodiments may be performed by processor unit 1404 using computer-implemented instructions, which may be located in a memory, such as memory 1406.

These instructions are referred to as program instructions, program code, computer usable program code, or computer readable program code that may be read and executed by a processor in processor unit 1404. The program code in the different embodiments may be embodied on different physical or computer readable storage media, such as memory 1406 or persistent storage 1408.

Program code 1418 is located in a functional form on computer readable media 1420 that is selectively removable and may be loaded onto or transferred to data processing system 1400 for execution by processor unit 1404. Program code 1418 and computer readable media 1420 form computer program product 1422 in these examples. In one example, computer readable media 1420 may be computer readable storage media 1424 or computer readable signal media 1426.

Computer readable storage media 1424 may include, for example, an optical or magnetic disk that is inserted or placed into a drive or other device that is part of persistent storage 1408 for transfer onto a storage device, such as a hard drive, that is part of persistent storage 1408. Computer readable storage media 1424 also may take the form of a persistent storage, such as a hard drive, a thumb drive, or a flash memory, that is connected to data processing system 1400. In some instances, computer readable storage media 1424 may not be removable from data processing system 1400.

In these examples, computer readable storage media 1424 is a physical or tangible storage device used to store program code 1418 rather than a medium that propagates or transmits program code 1418. Computer readable storage media 1424 is also referred to as a computer readable tangible storage device or a computer readable physical storage device. In other words, computer readable storage media 1424 is a media that can be touched by a person.

Alternatively, program code 1418 may be transferred to data processing system 1400 using computer readable signal media 1426. Computer readable signal media 1426 may be, for example, a propagated data signal containing program code 1418. For example, computer readable signal media 1426 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 1418 may be downloaded over a network to persistent storage 1408 from another device or data processing system through computer readable signal media 1426 for use within data processing system 1400. For instance, program code stored in a computer readable storage medium in a server data processing system may be downloaded over a network from the server to data processing system 1400. The data processing system providing program code 1418 may be a server computer, a client computer, or some other device capable of storing and transmitting program code 1418.

The different components illustrated for data processing system 1400 are not meant to provide architectural limitations to the manner in which different embodiments may be implemented. The different illustrative embodiments may be implemented in a data processing system including components in addition to or in place of those illustrated for data processing system 1400. Other components shown in FIG. 14 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

In another illustrative example, processor unit 1404 may take the form of a hardware unit that has circuits that are manufactured or configured for a particular use. This type of hardware may perform operations without needing program code to be loaded into a memory from a storage device to be configured to perform the operations.

For example, when processor unit 1404 takes the form of a hardware unit, processor unit 1404 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, programmable array logic, a field programmable logic array, a field programmable gate array, and other suitable hardware devices. With this type of implementation, program code 1418 may be omitted, because the processes for the different embodiments are implemented in a hardware unit.

In still another illustrative example, processor unit 1404 may be implemented using a combination of processors found in computers and hardware units. Processor unit 1404 may have a number of hardware units and a number of processors that are configured to run program code 1418. With this depicted example, some of the processes may be implemented in the number of hardware units, while other processes may be implemented in the number of processors.

In another example, a bus system may be used to implement communications fabric 1402 and may be comprised of one or more buses, such as a system bus or an input/output bus. Of course, the bus system may be implemented using any suitable type of architecture that provides for a transfer of data between different components or devices attached to the bus system.

Additionally, communications unit 1410 may include a number of devices that transmit data, receive data, or transmit and receive data. Communications unit 1410 may be, for example, a modem or a network adapter, two network adapters, or some combination thereof. Further, a memory may be, for example, memory 1406, or a cache, such as found in an interface and memory controller hub that may be present in communications fabric 1402.

The description of the different illustrative embodiments has been presented for purposes of illustration and description and is not intended to be exhaustive or to limit the embodiments in the form disclosed. Many modifications and variations will be apparent to those of ordinary skill in the art. Further, different illustrative embodiments may provide different benefits as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method of using a configuration software part for an aircraft, comprising:
identifying, by a processor unit on the aircraft, software parts for the aircraft from a list of approved software parts for an approved software configuration for the aircraft in the configuration software part, wherein the approved software configuration for the aircraft is identified in the configuration software part and the configuration software part is stored on the aircraft; and
determining, by the processor unit on the aircraft, whether the software parts identified in the configuration software part are on the aircraft.

2. The method of claim 1, wherein the configuration software part is part of an actual software configuration of the aircraft.

3. The method of claim 1, wherein the configuration software part comprises:
an identification certificate;
information identifying a plurality of approved software configurations for the aircraft;
the list of approved software parts for the aircraft for each of the plurality of approved software configurations; and
configuration rules identifying conditions in which the each of the plurality of approved software configurations is approved for the aircraft.

4. The method of claim 1, wherein the configuration software part comprises a number of supplier portions and an operator portion.

5. The method of claim 1 further comprising:
identifying, by the processor unit on the aircraft, an actual software configuration of the aircraft; and
determining, by the processor unit on the aircraft, whether the actual software configuration matches the approved software configuration for the aircraft identified in the configuration software part.

6. The method of claim 1 further comprising, in response to a determination that the software parts are not on the aircraft:
obtaining the software parts by the processor unit on the aircraft; and
storing the software parts on the aircraft by the processor unit on the aircraft.

7. The method of claim 1 further comprising:
identifying, by the processor unit on the aircraft, the software parts on the aircraft;
determining, by the processor unit on the aircraft, whether the software parts are identified in the list of approved software parts for the approved software configuration for the aircraft in the configuration software part; and
removing the software parts from the aircraft, by the processor unit on the aircraft, in response to a determination that the software parts are not identified in the list of approved software parts.

8. An apparatus, comprising:
a storage device on an aircraft;
a configuration software part for the aircraft stored in the storage device, wherein the configuration software part identifies an approved software configuration for the aircraft and comprises a list of approved software parts for the approved software configuration for the aircraft; and
a configuration manager on the aircraft configured to identify software parts from the list of approved software parts in the configuration software part stored in the storage device on the aircraft and determine whether the software parts identified in the list of approved software parts in the configuration software part are on the aircraft.

9. The apparatus of claim 8, wherein the configuration software part is part of an actual software configuration of the aircraft.

10. The apparatus of claim 8, wherein the configuration software part comprises:
an identification certificate;
information identifying a plurality of approved software configurations for the aircraft;
the list of approved software parts for the aircraft for each of the plurality of approved software configurations; and
configuration rules identifying conditions in which the each of the plurality of approved software configurations is approved for the aircraft.

11. The apparatus of claim 8, wherein the configuration software part comprises a number of supplier portions and an operator portion.

12. The apparatus of claim 8, wherein the configuration manager is configured to:
identify an actual software configuration of the aircraft; and
determine whether the actual software configuration matches the approved software configuration for the aircraft identified in the configuration software part.

13. The apparatus of claim 8, wherein the configuration manager is configured to obtain the software parts and store the software parts in the storage device in response to a determination that the software parts are not on the aircraft.

14. The apparatus of claim 8, wherein the configuration manager is configured to:
identify the software parts on the aircraft;
determine whether the software parts are identified in the list of approved software parts for the approved software configuration for the aircraft in the configuration software part; and
remove the software parts from the aircraft in response to a determination that the software parts are not identified in the list of approved software parts.

15. A method of providing a configuration software part for an aircraft, comprising:
receiving, by a processor unit, from a manufacturer of the aircraft, a manufacturer identification certificate, information identifying an approved manufacturer software configuration for the aircraft, a list of approved manufacturer software parts for the aircraft for the approved manufacturer software configuration, and cryptographic values for the approved manufacturer software parts;
receiving, by the processor unit, from an operator of the aircraft, an operator identification certificate, information identifying an approved operator software configuration for the aircraft, a list of approved operator software parts for the aircraft for the approved operator software configuration, and cryptographic values for the approved operator software parts;
combining, by the processor unit, the manufacturer identification certificate, the information identifying the approved manufacturer software configuration for the aircraft, the list of approved manufacturer software parts for the approved manufacturer software configuration, the cryptographic values for the approved manufacturer software parts, the operator identification certificate, the information identifying the approved operator software configuration for the aircraft, the list of approved operator software parts for the approved operator software configuration, and the cryptographic values for the approved operator software parts to form the configuration software part for the aircraft; and
providing the configuration software part for delivery to the aircraft by the processor unit.

16. The method of claim 15, further comprising:
receiving, by the processor unit, from the manufacturer of the aircraft, manufacturer configuration rules identifying first conditions in which each of a plurality of approved manufacturer software configurations is approved for the aircraft;
receiving, by the processor unit, from the operator of the aircraft, operator configuration rules identifying second conditions in which each of a plurality of approved operator software configurations is approved for the aircraft; and
including, by the processor unit, the manufacturer configuration rules, information identifying the plurality of approved manufacturer software configurations, the operator configuration rules, and information identifying the plurality of approved operator software configurations in the configuration software part for the aircraft.

17. The method of claim 15, further comprising:
determining, by the processor unit, whether software parts identified in one of the list of approved manufacturer software parts and the list of approved operator software parts in the configuration software part are in a software part library for providing the software part to the aircraft; and
obtaining the software parts and storing the software parts in the software part library, by the processor unit, in response to a determination that the software parts are not in the software part library.

18. The method of claim 15, wherein the configuration software part for the aircraft further comprises an identification of a number of previous configurations of the aircraft.

19. The method of claim 17 further comprising:
loading the configuration software part on the aircraft such that the configuration software part comprises a part of an actual software configuration of the aircraft;
using the configuration software part on the aircraft to manage the actual software configuration of the aircraft; and
using the configuration software part on the aircraft to manage software parts on the aircraft.

20. The method of claim 19, further comprising attaching a current identification certificate to a previous configuration software part stored on the aircraft.
